(19) United States
(12) Patent Application Publication
(10) Pub. No.: US 2009/0327059 A1
(43) Pub. Date: Dec. 31, 2009

(54) DIGITAL RIGHTS MANAGEMENT SUPPORT FOR METERING IN ADVERTISING SCENARIOS

(75) Inventor: Alexandre V. Grigorovitch, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/146,427

(22) Filed: Jun. 25, 2008

(51) Int. Cl. G06Q 30/00; G06Q 99/00; G06Q 10/00

(52) U.S. Cl. 705/14.15; 705/1; 705/30

(57) ABSTRACT

DRM support for metering in advertising scenarios is provided by an arrangement in which metering requests are included along with usage policies in licenses that grant rights to a presentation that comprises multiple pieces of metered media content that are sourced from different providers. A DRM runtime environment on a computing device such as a PC or mobile device will report metering data to locations specified in the metering requests while also enforcing the policies. The metering requests passed in the license enable each piece of media content in the presentation to be individually metered and the metering data sent to different entities at different locations. The DRM runtime environment on the computing device can prevent third parties from requesting that metering data be sent to other locations. The policies may be configured to block or restrict playback of media content if metering data is not submitted.

### BACKGROUND

Metering is a technology that enables digital media content providers to track the usage of protected media content such as video and audio. Metering is not generally used to track the consumption habits of individual users but is rather a tally of how many times a particular piece of media content item is used (for example, how often the media content is played or copied). Thus, metering can serve a number of possible business models, such as a fee-for-use model, or a subscription model where users pay a periodic fee, (for example, every month) to enjoy limited use of media content selected from an online catalog. If the user chooses not to continue his or her subscription, the licenses for any content simply expire, disabling playback.

A media content provider commonly enables a media player application running on a personal computer (“PC”) or mobile device with the capability to collect and report metering data for media content that has been protected with copy protection like digital rights management (“DRM”) technology. Metering provides several benefits, one of which is to reduce royalty fees for those content provider services that license content and then resell it to their customers. Royalty fees are based on the type of sale, such as whether the sale is a permanent transfer or a metered single play. Since the cost of a metered single play is much less than the cost of a permanent transfer, metering content is often much more economical for the content provider. Metering also provides other benefits. By metering content, a content provider can determine which content is more popular, identify and pay the artists whose content is played, and track the number of times an advertisement is viewed, for example.

While many DRM schemes often perform satisfactorily in most metering scenarios, current DRM functionality is not presently sufficient to deal with advertising-sponsored media content. In such cases, there could be more than one party involved in the creation and presentation of particular media content to a user where all such parties would need access to metering data. For example, if company ‘A’ distributes media content to users which is produced by company ‘B’ and which contains advertising from company ‘C’, then all three companies ‘A’, ‘B’, and ‘C’ might need to receive notification each time the media content is played.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

DRM support for metering in advertising scenarios is provided by an arrangement in which metering requests are included along with usage policies in licenses that grant rights to a presentation that comprises multiple pieces of metered media content that are sourced from different providers. A DRM runtime environment on a computing device such as a PC or mobile device will report metering data to locations specified in the metering requests while also enforcing the policies.

The metering requests passed in the license enable each piece of media content in the presentation, such as advertising and featured content, to be individually metered and the metering data sent to different entities at different locations. Because the metering requests are delivered with the policy information in the licenses, the DRM runtime environment on the computing device can prevent third parties from requesting that metering data be sent to other locations unless authorized by the media content providers. In addition, the policies may be configured to block or restrict playback of media content if metering data is not submitted.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative networked computing environment in which the present DRM support for metering in advertising scenarios may be implemented;

FIG. 2 shows an illustrative license that is configured to include policy expressions and a metering request;

FIG. 3 shows an illustrative presentation license that is configured to include two or more licenses;

FIG. 4 shows an illustrative scenario in which a presentation containing content and advertising and an associated presentation license are delivered to a computing device operated by a user;

FIG. 5 shows an illustrative arrangement in which a computing device sends metering data to multiple locations based on information contained in multiple policies;

FIG. 6 shows an illustrative arrangement in which metering data is prevented from being sent to a third party in response to a third party metering request;

FIG. 7 shows illustrative components that are operable on a client computing device that support implementation of the present DRM support for metering in advertising scenarios;

FIG. 8 shows an illustrative arrangement by which playback of content may be blocked if metering data cannot be submitted by a computing device; and

FIGS. 9 and 9A show a flowchart of an illustrative method for providing DRM-supported metering in advertising scenarios.

Like reference numerals indicate like elements in the drawings.

### DETAILED DESCRIPTION

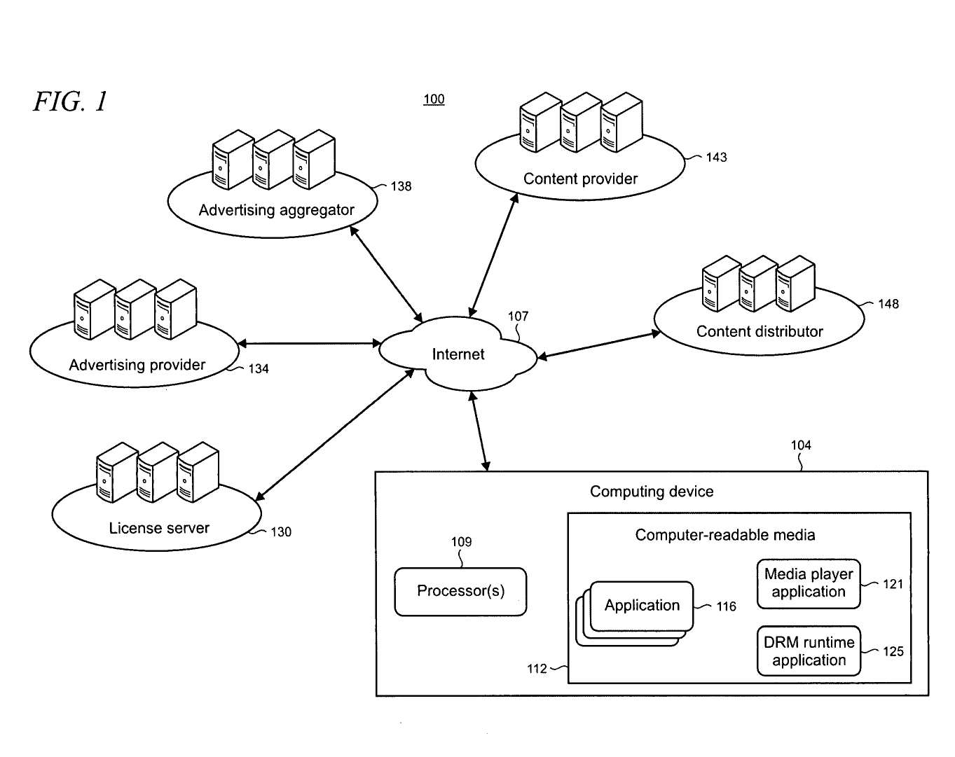

FIG. 1 shows an illustrative networked computing environment 100 in which the present DRM support for metering in advertising scenarios may be implemented which includes a computing device 104 that is coupled over a network such as the Internet 107 to a variety of different entities that are involved in the distribution of a presentation of media content that includes DRM-protected content and advertising.

The computing device 104 may comprise devices such as PCs, set-top boxes, game consoles, mobile phones, smart phones, personal digital assistants (“PDAs”), handheld game devices, portable media players, and the like that are capable of rendering media content such as video and audio. The computing device 104 is configured with one or more processors 109 and computer-readable media 112. The computer-readable media 112 includes one or more applications 116 that may be executed by the processors 109. Examples of computer-readable media 112 include volatile and non-volatile memory and/or storage media like ROM (read-only memory), RAM (random access memory), flash memory, hard disk, removable media, and the like.

The computer-readable media 112 may be configured to include a media player application 121 that may be utilized to render DRM-protected media content as described below in more detail. The media player application 121 supports a presentation runtime environment that includes software code which can generally render a presentation which includes different pieces of media content. In this example, the pieces include some form of featured media content (e.g., a song, television show, movie, video clip, etc.) as well as advertising that may come from different entities.

The computer-readable media 112 may be further configured with a DRM runtime application 125 that supports a DRM runtime environment. The presentation runtime and DRM runtime environments respectively supported by the media player application 121 and DRM runtime application 125 interact to enforce policies that are expressed in licenses that are associated with media content that can be rendered by the computing device 104.

The networked entities include, in this example, a license server 130, advertising provider 134, an advertising aggregator 138, a content provider 143, and a content distributor 148. The license server 130 is arranged to serve DRM licenses to various computing devices and/or users. The licenses typically describe and define the terms of use of a particular piece of media content. The licenses may also contain keys that allow media content that has been encrypted to be decrypted attendant to being subsequently rendered by a computing device and consumed by a user. In addition, as a given presentation may include media content from different sources, a license may contain policies that can affect usage rights associated with other pieces of content, as described in more detail below.

The advertising provider 134 provides advertising content that may be included in a presentation that is provided to the computing device 104. The advertising aggregator 138 is another possible source of advertising content, for example by consolidating advertising from multiple different sources, and may also be utilized to receive metering data, as described below, which can then be reported to the different advertising sources.

The content provider 143 is arranged to serve media content that is governed by one or more licenses that may be distributed by the license server 130. In some implementations, the content provider 143 may be the owner of the media content which is typically DRM-protected.

The content distributor 148 may be any type of content distributor that distributes media content to computing devices such as device 104. In some cases the content distributor 148 will be unaffiliated with the content provider 143 and advertising provider 134, except perhaps through contracts or similar business relationships. Generally, the content provider 143 will license the content distributor 148 to distribute its DRM-protected media content under various commercial terms. The content distributor 148 may also add its own advertising or advertising provided by the advertising provider 134 or advertising aggregator 138 to produce a presentation that it will distribute to the computing device 104. The advertising may be integrated with the media content from the content provider 143, or alternatively be distributed as separates files to the computing device 104.

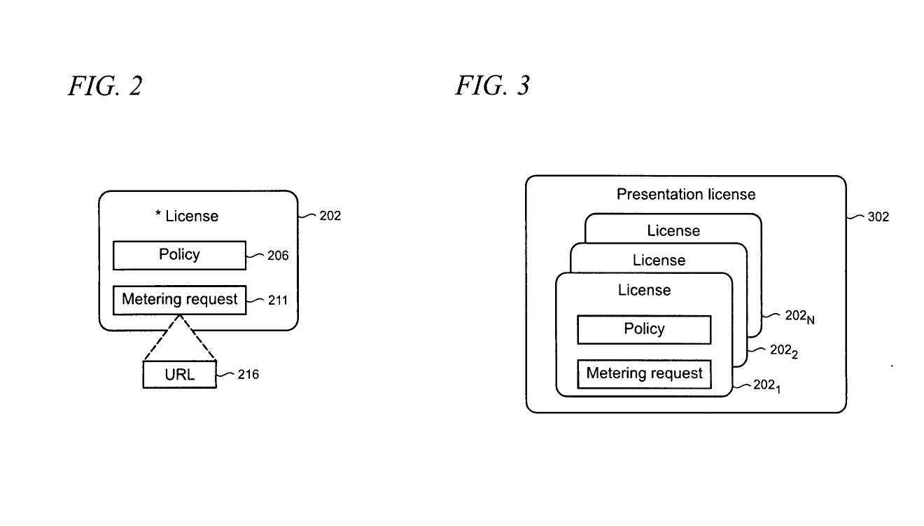

As shown in FIG. 2, each of the different pieces of media content may include, or be associated with its own individual license 202. Accordingly, there may be advertising content licenses and media content licenses that are utilized in the present arrangement for DRM support for metering in advertising scenarios. A license 202 will typically include a policy 206 that contains one or more expressions that govern usage rights, along with a metering request 211 that describes a location, using a URL (Uniform Resource Locator) 216 to which metering data may be sent by the computing device 104 when rendering the media content to which the license 202 is associated. The licenses 202 (e.g., one or more media content and advertising content licenses) may be served individually by the license server 130 or be combined into one presentation license 302 as shown in FIG. 3.

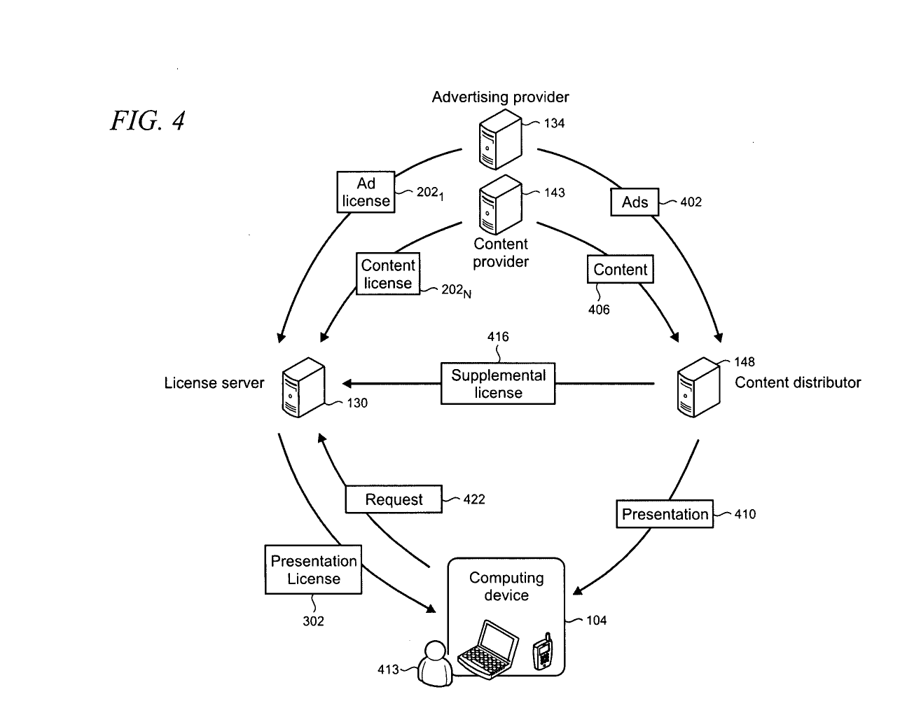

FIG. 4 shows the computing environment 100 of FIG. 1 with a number of elements removed for clarity. In this example, the advertising provider 134 (and/or advertising aggregator 138) has previously negotiated a commercial relationship by which an advertising license 202, may be served by the license server 130. In some instances, the associated advertising content 402 (referred to and shown as “ads”) herein) will be encrypted, in which case the advertising license 202, will include one or more keys. However, in other cases ads 402 will more simply be provided in the clear without encryption. Similarly, the content provider 143 will provide a content license 202_{N} in accordance with some pre-arranged relationship with the license server 130. Part of this process will typically include providing various keys separately or as part of the content license 202_{N} to the license server 130 as the associated content 406 will commonly be encrypted, although it may alternatively be provided in the clear.

As shown, the content provider 143 provides the content 406 associated with the content license 202_{N} to the content distributor 148 that it may use to build a presentation 410 that is distributed to a user 413 at the computing device 104 (e.g., a PC or mobile device as shown). In some cases the content distributor 148 will include additional media content to the presentation 410 such as other advertising or featured content. If so, then the content distributor 148 will typically provide a supplemental license 416 to the license server 130. The supplemental license may be configured, for example, in a similar manner as the license 202 shown in FIG. 2 and described in the accompanying text.

After receiving the presentation 410 which includes pieces of content from the multiple sources, as described above, the user 413 at the computing device 104 will typically attempt to render the content 406, which in this example is DRM-protected. The media player application 121 (FIG. 1) on the computing device 104 will communicate a request 422 to the license server 130. It is noted that the point in time in which the request 422 may be initiated may vary by implementation. For example, the request 422 may be made when the presentation 410 is received at the computing device 104 but before the user 413 attempts to play it.

Responsively to the request 422, the license server 130 will return individual licenses (e.g., licenses 202 and/or supplemental license 416) to the computing device 104. Or, as shown in FIG. 4, the license server 130 will return a presentation license 302 which combines the licenses into a single deliverable to the computing device 104.

Upon receipt of the presentation license 302, the presentation runtime environment and DRM runtime environment respectively supported by the media player application 121 and DRM runtime application 125 shown in FIG. 1 can operate collectively to ensure that the expressions contained in the policies 206 (FIG. 2) of the licenses 202 are executed accordingly.

The arrangements shown in FIGS. 1-4 may be used, for example, when the content provider 143 does not wish to be associated with or involved in the process of using third-party business models to distribute its content 406. By keeping the content encrypted 406 under a DRM model, it can remain safe. However, by virtue of the aforementioned business agreements among the content provider 143, advertising provider 134, and the content distributor 148, the content distributor may incorporate the content 406 and ads 402 (and possibly its own content) to the presentation 410. In this way, each entity may leverage its own business model. But for this interaction among the entities to be effective, it is observed that it would be desirable for metering of usage of the various pieces of media content contained in the presentation 410 to be implemented in a way that each entity can receive metering data directly without having to rely on a contracted party or third party.

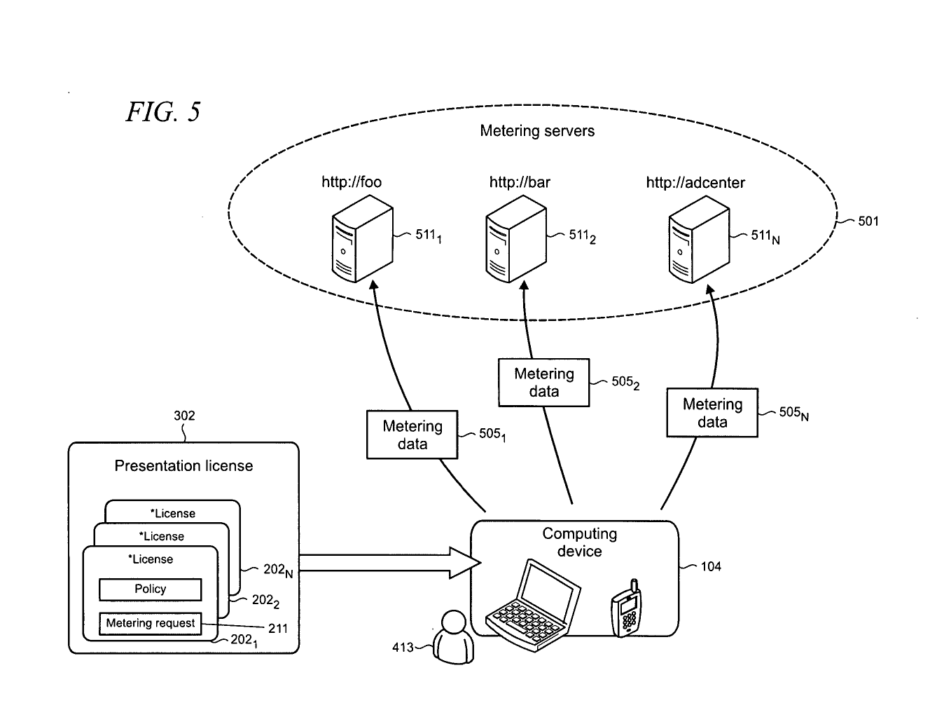

As shown in FIG. 5, such reporting of metering data may be effectuated through the metering requests 211 contained in the individual licenses 202 in the presentation license 302. In this example, each metering request 211 will request that metering data for content usage be reported by the DRM runtime application 125 (FIG. 1) running on the computing device 104 to the specified URL 216 (FIG. 2) associated with respective entities to which metering data is to be reported. That is, as a particular piece of media content is used or consumed by the user 413 at the computing device 104, metering data reflecting such usage is reported back to an appropriate metering server 501 for tracking and/or analytical purposes, for example.

Typically, the URL 216 can be embedded in a metering certificate that also includes a metering ID (identification) that is associated with the particular metered content that is the subject of the request. Accordingly, in some cases, a license 202 can include an entire metering certificate, or include just specific parts such as the URL as here, where the remaining components that may be needed to perform metering will be provided separately, for example, in a conventional manner. Generally, however, the URL 216 will be the minimum piece of metering information that may be included in the license to implement the present DRM support for metering in advertising scenarios.

As shown, metering data 505_{1, 2 . . . N} is returned to respective different metering servers 511_{1, 2 . . . N} where the URLs for the servers 511 are specified by the metering requests 211 in the presentation license 302. In this example, the URL “http://foo” is for the metering server 511₁ which collects metering data 505₁ for usage of content 406 (FIG. 4) provided by the content provider 143. The URL “http://bar” is for the metering server 511₂ which collects metering data 505₂ for usage of the presentation 410 (and/or supplemental content) provided by the content distributor 148. And, the URL “http://adcenter” is for the metering server 511_{N} which collects metering data 505_{N} for usage of the ads 402 provided by the advertising provider 134. It is emphasized that various combinations of metering servers 501 may be used in a given scenario. For example, one metering server may be used to collect metering data on behalf of more than one entity, or an entity may choose to use multiple metering servers to which usage is reported for a given piece of media content. Similarly, entities may wish to share a single metering server in some cases.

Advantageously, by combining a metering request with the license, the DRM runtime environment on the computing device 104 is enabled to report metering data to multiple locations so that usage of the various pieces of metered content that comes from different entities may be independently metered. In addition, this arrangement further prevents third parties from requesting that a computing device send metering data to other locations, or modifying an existing URL unless so authorized in the license.

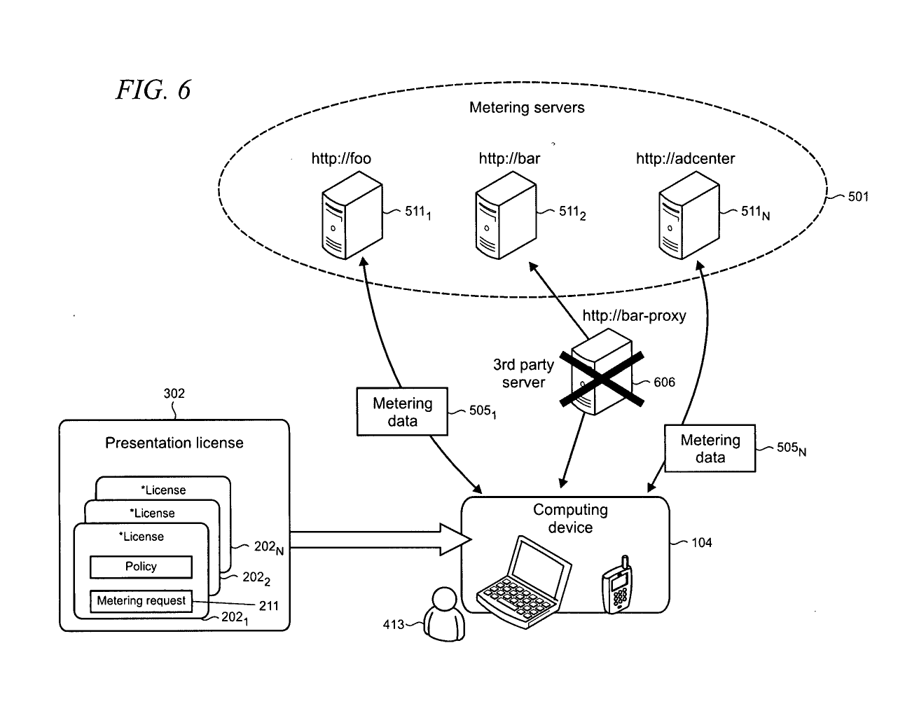

For example, as shown in FIG. 6, a third party server 606 having an address of “http://bar-proxy” cannot be independently specified as a metering URL. The DRM runtime environment can be configured to ignore all metering requests to generate metering data except for those that arrive as part of a license 202.

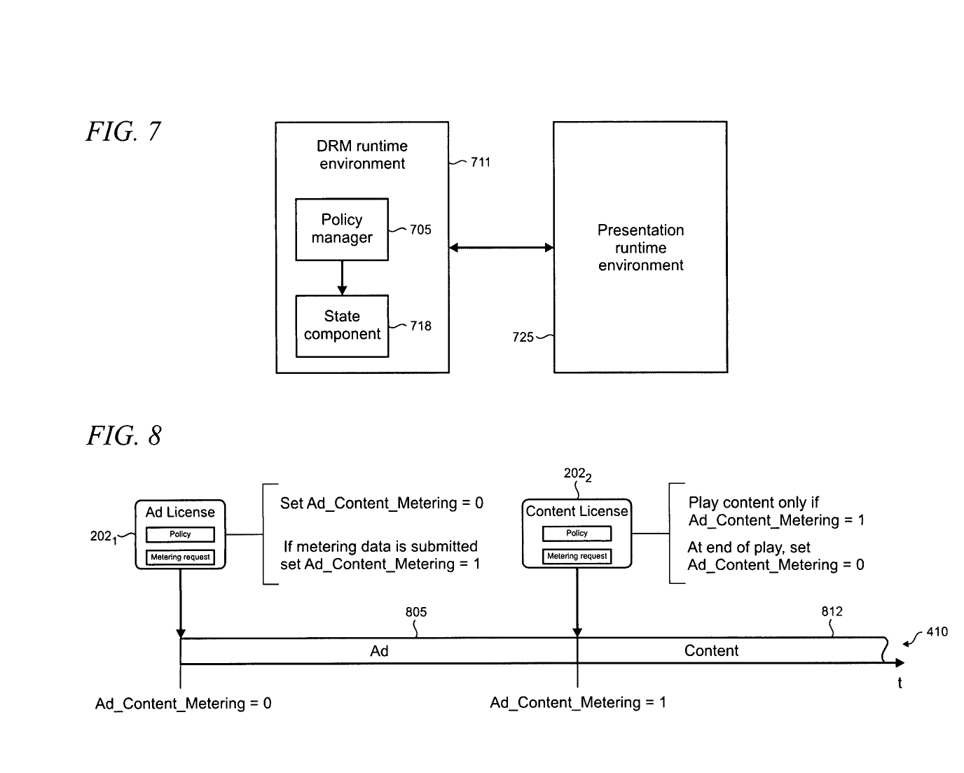

As noted above in the text accompanying FIG. 2, a license 202 is typically configured with expressions in a policy 206 that govern usage rights. As shown in FIG. 7, these policy expressions are analyzed by a policy manager 705 that is included in the DRM runtime environment 711. Policy manager 705 is in communication with a state component 718 and is configured to be able to set the state of the state component 718.

The DRM runtime environment 711 is in further communication with the presentation runtime environment 725 to receive information on the state of a particular presentation (e.g., presentation 410 in FIG. 4). This information may be used by the DRM runtime environment 711 to assign attribute values within the state component 718.

The policy expressions may be used to control media content playback behavior on the computing device by taking metering into account. FIG. 8 shows an illustrative scenario involving metered media content that comes from different sources and where metering data is reported to different locations. In this scenario, the presentation 410 comprises an ad 805 that is shown first, followed in time by some featured content 812 (e.g., movie, television show, video clip, etc.). In this example, the ad license 202₁ contains a policy expression that defines an attribute that takes a value depending on whether the metering data for the ad is submitted to the URL specified in the metering request in the ad license.

More specifically, in this scenario, an attribute “Ad_Content_Metering” is used to indicate whether metering data for the ad is submitted to the specified URL. The policy in the ad license 202₁ dictates that the attribute is initially set to “0” which indicates that metering data for the ad has not been submitted. After the metering data is submitted, which may occur, for example, before, during, or after the ad is rendered by the computing device, then the value for the attribute should be set to “1”.

The content license 202₂ includes a policy expression that the content 812 may be played by the computing device only if the “Ad-Content-Metering” attribute is set to “1”. In addition, the policy includes an expression that the attribute is reset when the content 812 reaches the end of its play. Accordingly, the ad license 202₁ includes policy expressions that impact the user's rights with respect to the content 812. And, the content license 202₂ includes policy expressions that define rights as a function of the state of the attribute associated with the ad.

Thus, in this scenario, if a metering server 501 specified in the URL does not receive metering data from the computing device 104, then the content 812 will not be playable. This could occur, for example, because the user 413 has not viewed the ad or has attempted to circumvent the applicable DRM protections to prevent the metering data from being reported.

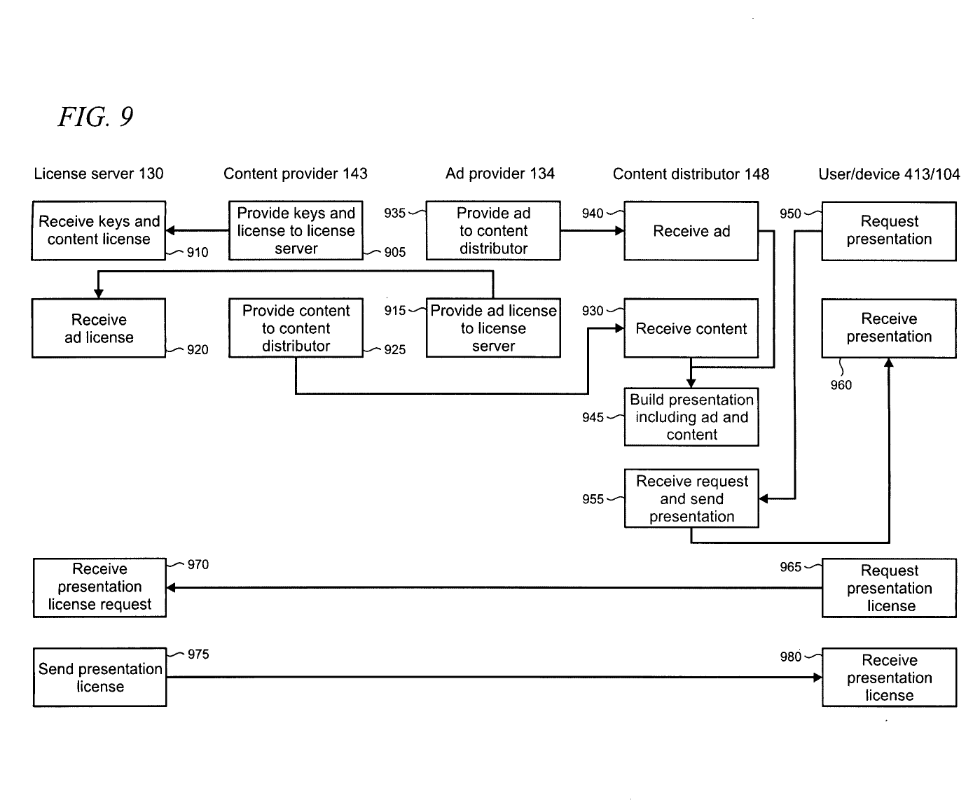

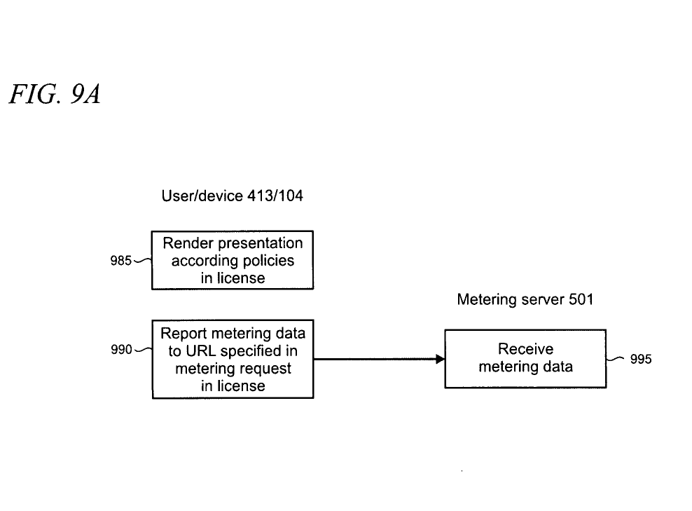

FIGS. 9 and 9A show a flowchart of an illustrative method that may be performed, for example, by the various elements shown in FIGS. 1-7 (and described in the accompanying text) to provide DRM support for metering in advertising scenarios. The numbered steps of the method are shown in parenthesis in the text below. The content provider 143 provides one or more content licenses 202₂ and any applicable decryption keys (905) which are received by the license server 130 (910). The ad provider 134 provides one or more ad licenses 202, (915) which are received by the license server 130 (920). The licenses 202 will typically include policies 206 and metering requests 211.

The content provider 143 provides content 406 (925) which is received by the content distributor 148 (930). In typical implementations, the content 406 will be DRM-protected, however in alternative implementations the content 406 may be provided in the clear. The advertising provider 134 (or alternatively, the advertising aggregator 138) provides one or more ads 402 (935) that are received by the content distributor 148 (940). Generally, the ads 402 will be provided in the clear.

The content distributor 148 can build a presentation 410 that includes the content 406 and ads 402 (945). The presentation 410 may also include additional content that is supplied from the content distributor 148 itself (if the additional content is DRM-protected, the content provider will provide the supplemental license 416 to the license server 130).

The user 413 at the computing device 104 sends a request 422 for the presentation 410 from the content distributor 148 (950). The content distributor 148 receives the request 422 and sends the presentation 410 (955) which is received by the user 413 at the computing device 104 (960). The computing device 104 will request the presentation license 302 (965) which can occur before the user 413 attempts to play the presentation or at the time the user attempts to play it.

The license server 130 receives the request 422 (970) and sends the presentation license 302 to the computing device 104 (975). The presentation license 302 may comprise multiple different licenses 202 that may be provided by different entities and be associated with different pieces of media content. The presentation license 302 sent from the license server 130 is received by the computing device 104 (980).

Turning to FIG. 9A, the presentation runtime environment 725 will render the presentation 410 according to the expressions contained in the policies 206 in the licenses 202 (985). Metering data 505 will be reported to the URL 216 specified in the metering request 211 in the license 202 (990) which is received by a metering server 501 (995).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-readable medium containing instructions which, when executed by one or more processors disposed on a computing device, perform a method for operating a DRM system on the computing device, the method comprising the steps of:
receiving a media content presentation that is playable on the computing device, the media content presentation comprising a plurality of individual pieces of media content that are provided by different providers, and usage of at least one piece of media content being individually metered; and
receiving a license containing i) one or more policies that govern usage of the media content presentation, and ii) at least one metering request that specifies a location to which metering data that is indicative of usage of the at least one piece of media content is reported.

2. The computer-readable medium of claim 1 in which the method includes a further step of blocking playback of a portion of the media content presentation if the metering data is not reported.

3. The computer-readable medium of claim 1 in which the individual pieces of media content respectively comprise pieces of advertising content and featured content.

4. The computer-readable medium of claim 1 in which the method includes a further step of blocking reporting metering data to a location operated by a third party unless authorized by a content provider in a license.

5. The computer-readable medium of claim 1 in which the DRM system comprises a DRM runtime environment that is supported by a DRM runtime application.

6. A method that is implemented at least in part in an automated manner for providing metering requests to a computing device that is arranged to render media content, the method comprising the steps of:
receiving an advertising license from an advertising provider, the advertising license being associated with renderable metered advertising content and including a metering request for a DRM system on the computing device to report metering data indicative of usage of the advertising content;
receiving a content license from a content provider, the content license being associated with renderable metered featured content and including a metering request for the DRM system on the computing device to report metering data indicative of usage of the featured content; and
sending the advertising license and content license to the computing device over a network.

7. The method of claim 6 including a further step of incorporating the advertising license and the content license into a single presentation license.

8. The method of claim 7 including a further step of receiving a request for the presentation license from the computing device and in which the sending is performed in response to receiving the request.

9. The method of claim 6 in which the request for metering data indicative of usage of the advertising content and the request for metering data indicative of usage of the featured content are included in respective metering certificates, each metering certificate including a URL and metering ID.

10. The method of claim 9 in which the URL specifies a location to which the metering data is reported.

11. The method of claim 6 including the further steps of receiving a second advertising license from a second advertising provider and incorporating the second advertising license into the presentation license.

12. The method of claim 6 including the further steps of receiving a second content license from a second content provider and incorporating the second content license into the presentation license.

13. The method of claim 6 in which the advertising license contains at least one policy governing usage of the advertising content or the featured content.

14. An automated method for providing a media content presentation to a computing device, the method comprising the steps of:
receiving advertising content from an advertising provider;
receiving featured content from a content provider;
building the media content presentation that incorporates the advertising content and the featured content, the media content presentation being arranged so that usage of the advertising content and the featured content is individually metered; and
distributing the media content presentation to the computing device over a network.

15. The automated method of claim 14 in which the featured content is DRM-protected.

16. The automated method of claim 14 in which the featured content comprises one of audio or video, the audio being selected from a group consisting essentially of music, audio book, podcast, news, or commentary, the video being selected from the group consisting essentially of television program, music video, video clip, movie, or feature film.

17. The automated method of claim 14 in which the computing device is one of PC, media center, game console, set-top box, PDA, portable media player, handheld game device, mobile phone, or smart phone.

18. The automated method of claim 14 in which the advertising content and featured content comprise discrete files.

19. The automated method of claim 14 including a further step of incorporating locally-sourced media content into the media content presentation.

20. The automated method of claim 19 in which the locally-sourced media content comprises additional advertising.
